(19) United States
(12) Patent Application Publication
(10) Pub. No.: US 2001/0046340 A1
(43) Pub. Date: Nov. 29, 2001

(54) ROLLER BEARING DEVICE

(76) Inventor: TOSHIAKI SHIMOMURA, KASHIWARA-SHI (JP)

Correspondence Address: ADAMS & WILKS, 50 BROADWAY, 31ST FLOOR, NEW YORK, NY, 10004

(21) Appl. No.: 09/166,651

(22) Filed: Oct. 5, 1998

(30) Foreign Application Priority Data
Oct. 6, 1997 (JP) 9-289155

(51) Int. Cl. F16C 19/24

(52) U.S. Cl. 384/548; 384/557

(57) ABSTRACT

A roller bearing device having two roller bearings positioned in an axially spaced relation, in which even when in high speed rotation, a fixed pilot pressure of bearings is maintained by differentiating the thermal expansibility of a distance piece between tracks of the roller bearings and the thermal expansibility of a collar interposed between the track race and a mating member.

### FIELD OF THE INVENTION

The present invention relates to a roller bearing device, and to a roller bearing device, for example, for a machine tool.

### BACKGROUND OF THE INVENTION

For example, a conventional roller bearing device for a machine tool is shown in FIG. 1.

The construction of this roller bearing device comprises two back-mated roller bearings 20, 21 positioned in an axial spaced relation, a housing 26 having outer races 22, 23 of the two roller bearings 20, 21 fitted in and secured thereto, a shaft 27 inserted into inner races 24, 25 of the two roller bearings 20, 21 and rotatably supported, distance pieces 28, 29 arranged between the outer races 22, 23 and between the inner races 24, 25, respectively, of the two roller bearings 20, 21, and a pilot pressure member mounted on the shaft 27 to press the inner race 24 to apply an axial pilot pressure to the two roller bearings 20, 21.

Incidentally, in the conventional roller bearing device for a machine tool, it is sometimes that the pilot pressure applied to the bearing during rotation of the bearing device increases to generate baking in the bearing, due to a difference in temperature between the inner and outer races and a centrifugal force of an inner race track when in rotation at high speeds. As measures to meet the above situation, for the distance piece of the outer race, use is made of a Fe—Ni base alloy which is relatively smaller in thermal expansibility than high carbon chrome bearing steel steel material SUJ2 (C: 0.095˜1.10, Si: 0.15˜0.35, Mn: 0.50 or less, P: 0.025 or less, S: 0.025 or less, Cr: 1.30˜1.60%) of material for the outer race (Japanese Industrial Standards), or for the distance piece of the inner race, use is made of an aluminum alloy which is relatively larger in thermal expansibility than SUJ2 of material for the inner race, thus suppressing the increase of pilot pressure of the bearing.

In the conventional roller bearing device for a machine tool as described above, in the case where material of small thermal expansibility as previously mentioned is used for the distance piece 28 of the outer race, since the axial thermal expansibility on the outer race side is smaller than that of the housing 26 formed of Fe material, a clearance becomes formed between the outer race and a keep lid 33 to lower the rigidity of a main shaft. Further, in the case where material of large thermal expansibility as previously mentioned is used for the distance piece 29 of the inner race, since the shaft 27 formed of Fe material does not extend axially as compared with the distance piece 29 for the inner race, the axial elongation of the distance piece 29 of the inner race is suppressed to make it difficult to suppress the increase in pilot pressure of the bearing.

### SUMMARY OF THE INVENTION

It is an object of the present invention to provide a roller bearing device in which even when in high speed rotation, a fixed pilot pressure of a bearing is maintained.

The construction of a roller bearing device according to the present invention comprises two rolling bearings positioned in an axial spaced relation, a housing having outer races of the two roller bearings fitted in and secured thereto, a shaft inserted into inner races of the two roller bearings and supported rotatably, distance pieces arranged between the outer races and between the inner races, respectively, of the two roller bearings, a collar arranged between an end of the outer race of either of the bearings and an end of an outer race fixing portion on the housing side, a pilot pressure member for pressing the inner race mounted on the shaft to apply an axial pilot pressure to the two roller bearings, and pilot pressure regulating means for regulating the pilot pressure by differentiating the thermal expansibility of the distance piece arranged between the outer races and the thermal expansibility of the collar.

According to an alternative embodiment, there is disclosed a roller bearing device in which a collar is arranged between ends of an inner race fixing portion on the shaft side of an end of the inner race of either of the bearings, and the thermal expansibility of the distance piece arranged between the inner races and the thermal expansibility of the collar are differentiated.

According to another embodiment, there is disclosed a roller bearing device in which a first collar is arranged between an end of the outer race of either of bearings and an end of an outer race fixing portion on the housing side, a second collar is arranged between an end of the inner race of either of bearings and an end of an inner race fixing portion on the shaft side, the thermal expansibility of the distance piece arranged between the outer races and the thermal expansibility of the collar on the outer race side are differentiated, and the thermal expansibility of the distance piece arranged between the inner races and the thermal expansibility of the collar on the inner race side are differentiated

As described above, according to the bearing device of the present invention, the thermal expansibility of the distance piece between the track races and the thermal expansibility of the collar interposed between the track race and the mating member are differentiated whereby even when in high speed rotation, a fixed pilot pressure of bearings is maintained.

### BRIEF DESCRIPTION OF THE DRAWINGS

FIG. 1 is a sectional view of a roller bearing device according to the present invention; and

FIG. 2 is a sectional view of a conventional roller bearing device.

### DESCRIPTION OF THE PREFERRED EMBODIMENTS

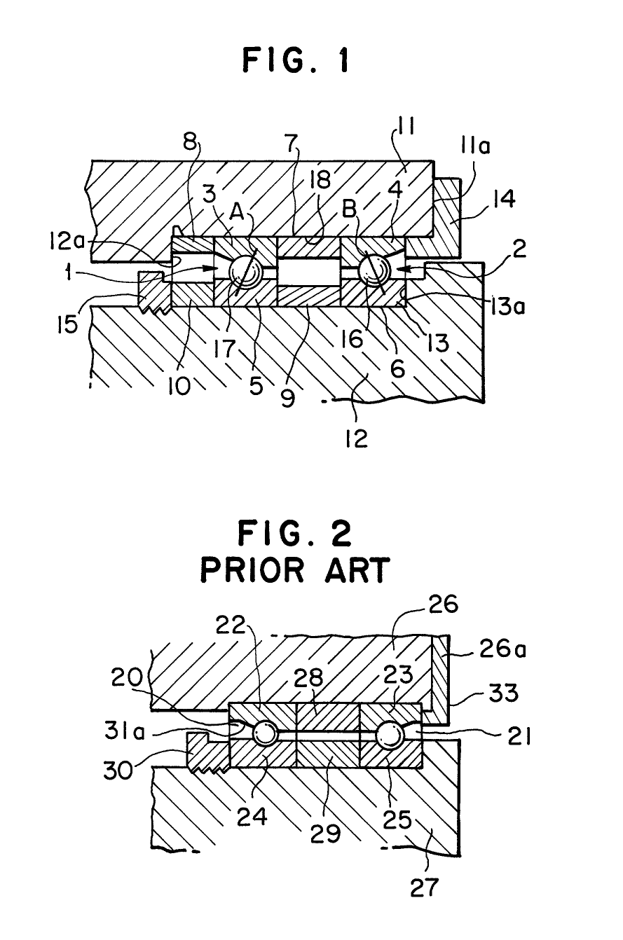

FIG. 1 shows one embodiment of a roller bearing device according to the present invention. A housing 11 has two roller bearings (angular ball bearings) 1, 2 arranged in a spaced relation, and outer races 3, 4 of the two roller bearings 1, 2, said two roller bearings and said outer races being fitted in and secured to said housing. A shaft 12 is inserted into inner races 5, 6 of the two roller bearings 1, 2 and supported rotatably. Distance pieces 7, 9 are arranged between the outer races 3, 4 of the two roller bearings 1, 2 and between the inner races 5, 6, respectively. A nut 15 is mounted on the shaft 12 to press the inner race 5. Accordingly, this nut 15 is to apply an axial pilot pressure to the two roller bearings 1, 2.

Both the outer races 3, 4 are arranged within a shoulder 18 of the housing 11. One outer race 3 is supported on a shoulder end 12a of the housing 11 through a collar 8. The other outer race 4 is fixed by means of a keep lid 14 mounted on a housing side 11a. The inner race 6 opposed to the other outer race 4 of both the inner races 5, 6 is placed in contact with an end 13a of a shaft shoulder 13, and the inner race 5 opposed to the one outer race 3 is fastened and fixed through a collar 10 by means of a nut 15 as a pilot pressure member threadedly engaged with the shaft 12. With this, a fixed axial pilot pressure is applied to the two ball bearings 1, 2. The two roller bearings (angular ball bearings) 1, 2 are so designed that their functional lines A and B cross on the housing 11 side between the two bearings 1, 2. That is, the bearings are in the back-mated state. Reference numerals 16, 17 designate balls. The inner races 5, 6 and the outer races 3, 4 are formed of SUJ2, and the housing 11 and the shaft 12 are formed of Fe.

In the first embodiment, the thermal expansibility of the distance piece 7 arranged between the outer races 3, 4 is made smaller than that of the collar 8 on the outer race side. For example, the distance piece 7 is formed of a Fe—Ni alloy, and the collar 8 is formed of an aluminum alloy. The distance piece 7 is smaller in thermal expansibility than that of the outer races 3, 4 and the housing 11, and the collar 8 is greater in thermal expansibility than that of the outer races 3, 4 and the housing 11.

With this constitution, the entire axial elongation on the sides of the outer races 3, 4 of both the bearings are made adequate relative to the housing 11 according to the magnitude relation between the axial elongation of the distance piece 7 and the axial elongation of the collar 8. Accordingly, occurrence of a clearance between the outer race 4 and the keep lid 14 is prevented, and a fixed pilot pressure is maintained.

Further, in the second embodiment, the distance piece 9 arranged between the inner races 5, 6 is made greater in thermal expansibility than that of the collar 10 on the inner race side. For example, the distance piece 9 is formed of an aluminum alloy, and the collar 10 is formed of a Fe—Ni alloy. The distance piece 9 is greater in thermal expansibility than that of the outer races 5, 6 and the shaft 12, and the collar 8 is smaller in thermal expansibility than that of the outer races 5, 6 and the shaft 12.

With this constitution, the entire axial elongation of both the inner races 5, 6 is adequate relative to the shaft 12, and an increase in pilot pressure of the two bearings 1, 2 is prevented.

Further, in the third embodiment, by a combination of the aforementioned first and second embodiments, the pilot pressure of the two roller bearings 1, 2 is maintained properly more effectively.

While in the above-described respective embodiments, an example has been described in which the bearings are back-mated, it is to be noted that conversely, in the case where the bearings are front-mated, the magnitude relation between the distance piece on the inner race side and the thermal expansibility of the collar are reversed to the case of the aforementioned embodiments.

1. A roller bearing device comprising:
two rolling bearings positioned in an axial spaced relation;
a housing having outer races of the two roller bearings fitted in and secured thereto;
a shaft inserted into inner races of the two roller bearings and supported rotatably, distance pieces arranged between the outer races and between the inner races, respectively, of the two roller bearings;
a collar arranged between an end of the outer race of either of the bearings and an end of an outer race fixing portion on the housing side;
a pilot pressure member for pressing the inner race mounted on the shaft to apply an axial pilot pressure to the two roller bearings; and
pilot pressure regulating means for regulating the pilot pressure by differentiating the thermal expansibility of the distance piece arranged between the outer races and the thermal expansibility of the collar.

2. The roller bearing device according to claim 1, wherein said pilot pressure member comprises a nut.

3. A roller bearing device comprising:
two rolling bearings positioned in an axial spaced relation;
a housing having outer races of the two roller bearings fitted in and secured thereto;
a shaft inserted into inner races of the two roller bearings and supported rotatably;
distance pieces arranged between the outer races of the two roller bearings and between the inner races, respectively;
a collar arranged between an end of the inner race of either of two bearings and an end of an inner race fixing portion on the shaft side;
a pilot pressure member for pressing the inner mounted on said shaft to apply an axial pilot pressure to the two roller bearings; and
pilot pressure regulating means for regulating said pilot pressure by differentiating the thermal expansibility of the distance piece arranged between the inner races and the thermal expansibility of the collar.

4. The roller bearing device according to claim 3, wherein said pilot pressure member comprises a nut.

5. A roller bearing device comprising:
two rolling bearings positioned in an axial spaced relation;
a housing having outer races of the two roller bearings fitted in and secured thereto;
a shaft inserted into inner races of the two roller bearings and supported rotatably;
distance pieces arranged between the outer races and between the inner races, respectively, of the two roller bearings;
a first collar arranged between an end of the outer race of either of the bearings and an end of an outer race fixing portion on the housing side;
a second collar arranged between an end of the inner race of either of the bearings and an end of an inner race fixing portion on the shaft side;
a pilot pressure member for pressing the inner race mounted on said shaft to apply an axial pilot pressure to the two roller bearings; and
pilot pressure regulating means for regulating said pilot pressure by differentiating the thermal expansibility of the distance piece arranged between said inner races and the thermal expansibility of said second collar on the inner race side.

6. The roller bearing device according to claim 5, wherein said pilot pressure member comprises a bolt.
